(19) United States
(12) Patent Application Publication
(10) Pub. No.: US 2017/0270699 A1
(43) Pub. Date: Sep. 21, 2017

(54) ELECTRONIC DEVICE

(71) Applicant: Seiko Epson Corporation, Tokyo (JP)

(72) Inventor: Kiyotaka KOIDE, Okaya (JP)

(21) Appl. No.: 15/451,795

(22) Filed: Mar. 7, 2017

(30) Foreign Application Priority Data
Mar. 18, 2016 (JP) 2016-054963

(51) Int. Cl. G06T 11/60; G04G 9/00; A44C 5/14; G04B 45/00; G04B 37/14

(52) U.S. Cl. CPC G06T 11/60; G04B 45/0076; G04B 37/1486; A44C 5/14; G04G 9/0005

(57) ABSTRACT

A wristwatch includes a main unit, a first design belt detachably attached to the main unit, an identifier that identifies the first design belt, a display device that displays the display content, a memory that stores the display content displayed on the display device, and a display control unit that displays the display content corresponding to the first design belt identified by the identifier on the display device.

### BACKGROUND

1. Technical Field

The present invention relates to an electronic device.

2. Related Art

A portable electronic device that is worn on an arm and displays a time, various information items, and an image on a display unit has been widely used. Hereinafter, the image is referred to as display content. A portable electronic device which has various functions by devising the display content has been developed. As mentioned above, the portable electronic device that displays the information is disclosed in JP-A-11-133168. According to this technology, the portable electronic device has a function of a timepiece. The portable electronic device includes a main unit that displays information, and a belt that fixes the main unit onto the wrist. A unit including an electronic circuit is provided at the belt.

Since the portable electronic device worn onto the wrist has high fashionability and looks like a part of fashion from others, an article having a distinctive design is desirable. If the same design of portable electronic device is worn on the wrist for a long period of time, this portable electronic device looks old-fashioned and is boring, and thus, a change in design thereof may be desired. When the display content is displayed on the display unit, if a design of the belt and impression of the display content displayed on the main unit can be combined depending on a wearer's flavor, since the portable electronic device shows variations, it is possible to continuously use the portable electronic device without looking old-fashioned.

In the portable electronic device described in JP-A-11-133168, the display unit is provided in the main unit. The main unit and the belt are connected by a spring rod. Accordingly, the belt is detachably attached to the main unit. A combination of the main unit and the belt can be changed. However, since the main unit is not able to identify the attached belt, the display content appropriate for the design of the belt is not able to be displayed on the display unit.

### SUMMARY

An advantage of some aspects of the invention is to provide an electronic device capable of displaying the display content matching the design of the exterior decoration unit such as the belt on the display unit.

The invention can be implemented as the following forms or application examples.

### Application Example 1

An electronic device according to this application example includes: a main unit; an exterior decoration unit that is detachably attached to the main unit; an identification unit that identifies the exterior decoration unit; a display unit that displays display contents; a storage unit that stores the display content displayed on the display unit; and a control unit that displays the display content corresponding to the exterior decoration unit identified by the identification unit on the display unit.

According to this application example, the electronic device includes the main unit, the exterior decoration unit, and the identification unit. The exterior decoration unit is detachably attached to the main unit, and the identification unit identifies the exterior decoration unit. The electronic device includes the display unit, the storage unit, and the control unit. The display unit displays the display content, and the display content displayed on the display unit is stored in the storage unit. The control unit displays the display content corresponding to the design of the exterior decoration unit identified by the identification unit on the display unit.

The exterior decoration unit can be detached from the main unit, and can be re-attached. In this case, an exterior decoration unit having a different design can be attached to the main unit. The identification unit identifies which exterior decoration unit of a plurality of exterior decoration units having different designs is attached to the main unit. The display content is stored in the storage unit. The control unit reads the display content corresponding to the exterior decoration unit identified by the identification unit from the storage unit, and displays the read display content on the display unit. Accordingly, the electronic device can display the display content appropriate for the design of the exterior decoration unit on the display unit.

### Application Example 2

In the electronic device according to the application example, the exterior decoration unit may include an identification feature unit, and the identification unit may identify the exterior decoration unit by using the identification feature unit.

According to this application example, the exterior decoration unit includes the identification feature unit. The identification feature unit is a portion having a different feature for each exterior decoration unit. The identification unit identifies the exterior decoration unit by using the identification feature unit. Accordingly, the identification unit can identify the exterior decoration unit.

### Application Example 3

In the electronic device according to the application example, the identification feature unit may include an electrical terminal.

According to this application example, the identification feature unit includes the electrical terminal. Accordingly, the identification unit is connected to the electrical terminal, and electrically identifies the exterior decoration unit. Therefore, the identification unit can easily identify the exterior decoration unit.

### Application Example 4

In the electronic device according to the application example, the identification feature unit may include a first antenna that outputs an identification signal, and the identification unit may include a second antenna that receives, as an input, the identification signal.

According to this application example, the identification feature unit includes the first antenna, and the first antenna outputs a radio signal including the identification signal. The identification unit includes the second antenna, and the second antenna receives, as the input, a radio signal including the identification signal. Accordingly, the identification unit can identify the exterior decoration unit in a non-contact manner.

### Application Example 5

The electronic device according to the application example may further include: an attachment and detachment detection unit that detects attachment or detachment of the exterior decoration unit to or from the main unit. The identification unit may communicate the identification signal when the attachment and detachment detection unit detects the attachment of the exterior decoration unit to the main unit.

According to this application example, the main unit includes the attachment and detachment detection unit, and the attachment and detachment detection unit detects the attachment or detachment of the exterior decoration unit to or from the main unit. When the exterior decoration unit is attached to the main unit, the identification unit communicates the identification signal. Accordingly, since the number of times the identification unit and the identification feature unit communicate with each other can be reduced, the power consumed in the communication of the identification unit and the identification feature unit can be reduced.

### Application Example 6

In the electronic device according to the application example, information indicating a current time may be included in the display content.

According to this application example, the information indicating the current time is included in the display content. Accordingly, the operator can check the current time while viewing the display content.

### BRIEF DESCRIPTION OF THE DRAWINGS

The invention will be described with reference to the accompanying drawings, wherein like numbers reference like elements.

FIG. 1 is a schematic plan view showing a configuration of a wristwatch according to a first embodiment.

FIG. 2 is a schematic diagram of major portions for describing a coupling portion of a main unit and a first design belt.

FIG. 3 is a schematic side sectional view of major portions for describing a configuration of an identifier.

FIG. 4 is a schematic plan view showing a configuration of the wristwatch.

FIG. 5 is a schematic diagram of major portions for describing a coupling portion of the main unit and a second design belt.

FIG. 6 is a schematic plan view of major portions showing a configuration of a third design belt.

FIG. 7 is a schematic plan view of major portions showing a configuration of a fourth design belt.

FIG. 8 is a schematic plan view of major portions showing a configuration of a fifth design belt.

FIG. 9 is a schematic plan view of major portions showing a configuration of a sixth design belt.

FIG. 10 is a schematic plan view of major portions showing a configuration of a seventh design belt.

FIG. 11 is a schematic plan view of major portions showing a configuration of an eighth design belt.

FIG. 12 is a schematic plan view of major portions showing a configuration of a ninth design belt.

FIG. 13 is a schematic plan view of major portions showing a configuration of a tenth design belt.

FIG. 14 is an electric control block diagram of the wristwatch.

FIG. 15 is a flowchart of a display content display method.

FIG. 16 is a schematic plan view showing a configuration of a wristwatch according to a second embodiment.

FIG. 17 is a schematic diagram of major portions for describing a coupling portion of a main unit and a first design belt.

FIG. 18 is a circuit diagram of an identification signal transmission unit and an identification signal reception unit.

FIG. 19 is an electric control block diagram of the wristwatch.

FIG. 20 is a flowchart of a display content display method.

### DESCRIPTION OF EXEMPLARY EMBODIMENTS

Hereinafter, exemplary embodiments will be described with reference to the drawings. The respective members in the respective drawings have sizes capable of being recognized in the respective drawings, and thus, the respective members are illustrated such that scales thereof are different from one another.

### First Embodiment

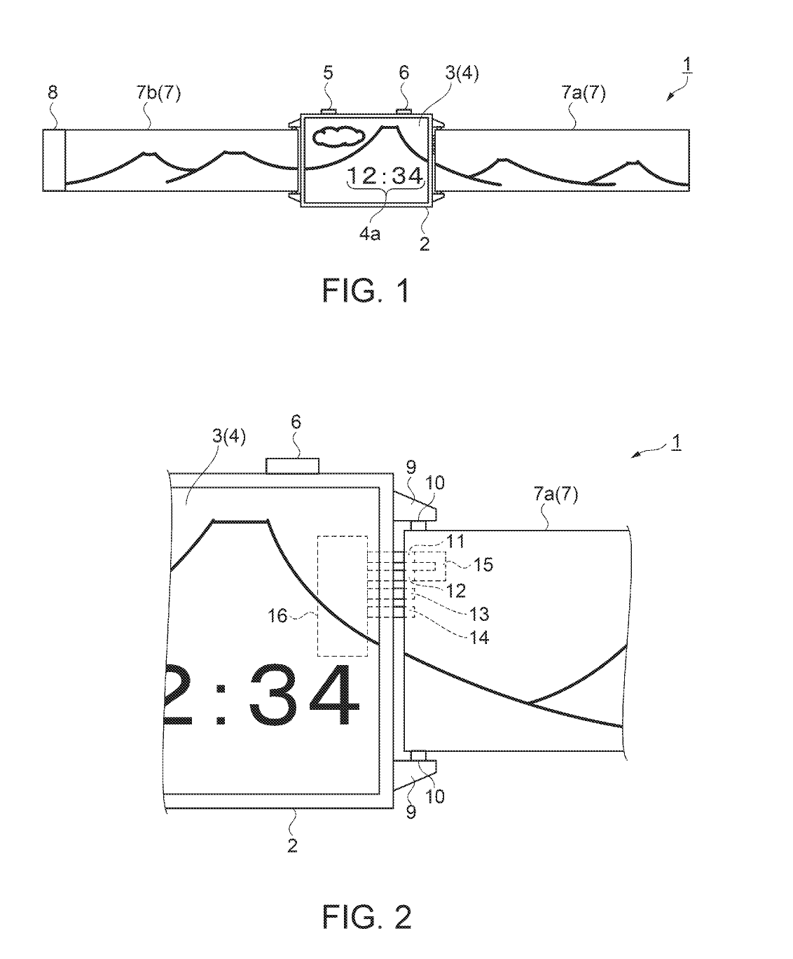

In the present embodiment, characteristic examples of a wristwatch which is an example of an electronic device and a method of replacing a belt of the wristwatch will be described with reference to the drawings. A wristwatch according to a first embodiment will be described with reference to FIGS. 1 to 15. FIG. 1 is a schematic plan view showing a configuration of the wristwatch. As shown in FIG. 1, a wristwatch 1 as the electronic device includes a main unit 2, and a display device 3 as a display unit is provided in the main unit 2.

A display method of the display device 3 is not particularly limited, and a liquid crystal display, an organic electroluminescence (EL) display, an electrophoretic display, or a microelectromechanical systems (MEMS) display may be used. The display device 3 is preferably an active matrix type. Accordingly, the display device 3 may perform high-definition display. A first image 4 as a display content is displayed on the display device 3, and information 4a indicating a current time is included in the first image 4.

A first operation switch 5 and a second operation switch 6 are provided on a lateral surface of the main unit 2 on an upper side of the drawing. An operator may operate the display content of the display device 3 by operating the first operation switch 5 and the second operation switch 6. A first belt 7a is provided on a lateral surface of the main unit 2 on a right side of the drawings, and a second belt 7b is provided on a lateral surface of the main unit 2 on a left side of the drawing. A connection portion 8 is provided at an end of the second belt 7b close to the left side of the drawing. The operator may fix the end of the first belt 7a to the connection portion 8. The connection portion 8 connects the first belt 7a and the second belt 7b.

The operator wraps the first belt 7a and the second belt 7b around the wrist of the operator. The operator connects the first belt 7a and the second belt 7b by operating the connection portion 8. Accordingly, the operator may fix the wristwatch 1 to the wrist of the operator. A picture is drawn on the first belt 7a and the second belt 7b. The content of the picture is not particularly limited, and for example, a picture of a mountain chain is drawn on the first belt 7a and the second belt 7b in the present embodiment. It is assumed that the belt including the first belt 7a and the second belt 7b is a first design belt 7 as an exterior decoration unit.

When the first design belt 7 is attached to the main unit 2, the picture of the mountain chain is displayed as the first image 4 displayed on the display device 3. The first image 4 is a display content corresponding to the first design belt 7, and is the display content appropriate for the picture drawn on the first design belt 7.

FIG. 2 is a schematic diagram of major portions for describing a coupling portion of the main unit and the first design belt. As shown in FIG. 2, a pair of projections protrudes from lateral surfaces of the main unit 2 on the right side of the drawing. The projections are referred to as lugs 9. The end of the first design belt 7 is provided between the pair of lugs 9. A through hole that penetrates the first design belt 7 in the vertical direction in the drawing is formed in the first design belt 7 between the pair of lugs 9, and a spring rod 10 is provided in the through hole. A spring may be provided within the spring rod 10, and may be expanded and contracted. Holes are respectively formed in surfaces of the lugs 9 facing the first design belt 7. The spring rod 10 passes through the through hole of the first design belt 7, and both ends of the spring rod 10 are inserted into the holes of the lugs 9. As stated above, the spring rod 10 is operated, and thus, the first design belt 7 can be provided so as to be detachably attached to the lugs 9 of the main unit 2.

A first terminal 11, a second terminal 12, a third terminal 13, and a fourth terminal 14 are formed at the first belt 7a. The first terminal 11, the second terminal 12, the third terminal 13, and the fourth terminal 14 are exposed from the lateral surface of the first belt 7a, and are equivalent to electrical terminals. The first terminal 11 and the second terminal 12 are connected by an electrical wiring 15. The third terminal 13 and the fourth terminal 14 are independent terminals.

An identifier 16 as an identification unit is provided within the main unit 2. The identifier 16 is a circuit that detects connection states of the first terminal 11, the second terminal 12, the third terminal 13, and the fourth terminal 14 with each terminal. The identifier 16 detects short circuit and non-short circuit states between the respective terminals. A plurality of belts such as the first design belt 7 is prepared. The short circuit and non-short circuit states between the respective terminals are different for types of belts. Accordingly, the identifier 16 can identify the types of the belts attached the main unit 2 by detecting the short circuit and non-short circuit states between the respective terminals. The first terminal 11, the second terminal 12, the third terminal 13, the fourth terminal 14, and the electrical wiring 15 are equivalents to identification feature units for causing the identifier 16 to identify the respective belts. Accordingly, the identification feature unit includes an electrical terminal. The identifier 16 identifies the first design belt 7 by using the first terminal 11 to fourth terminal 14.

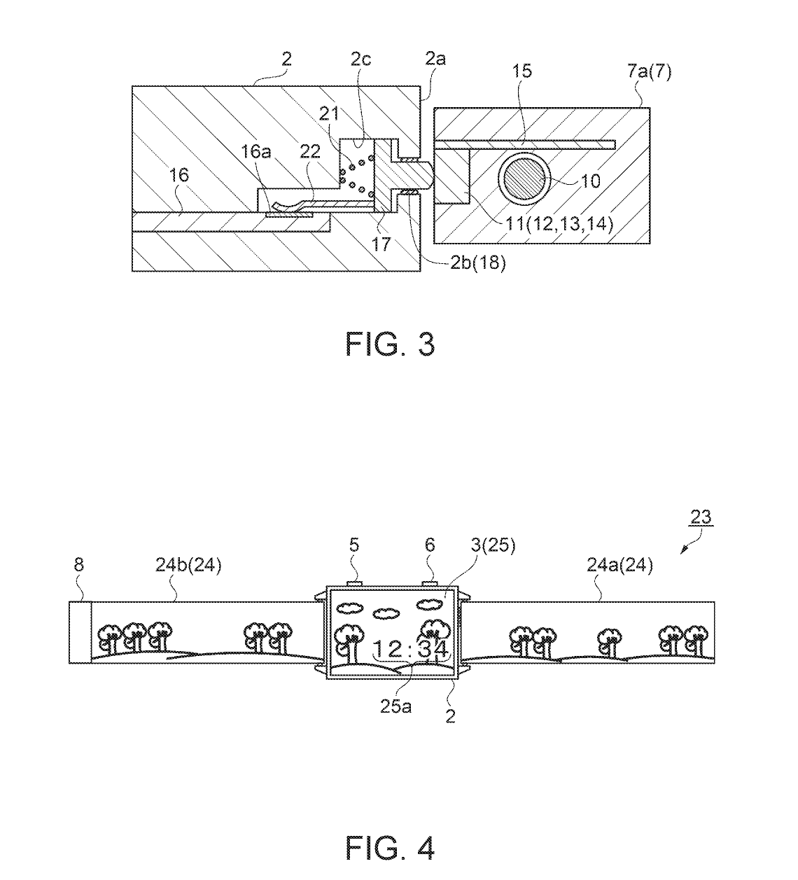

FIG. 3 is a schematic side sectional view of major portions for describing a configuration of the identifier. As shown in FIG. 3, holes 2b with a direction perpendicular to a lateral surface 2a as an axis so as to face the first belt 7a are formed in the lateral surface 2a of the main unit 2. Four holes 2b are formed, and the holes 2b are positioned in locations facing the first terminal 11, the second terminal 12, the third terminal 13, and the fourth terminal 14. A cavity 2c is formed within the main unit 2, and the holes 2b are communicatively connected to the cavity 2c. Contact portions 17 acquired by coupling a circular plate and a rod with the same axis are provided in the holes 2b and the cavity 2c. Four contact portions 17 are provided in the main unit 2. A rod-shaped portion of the contact portion 17 is inserted into the hole 2b, and a packing 18 is provided between the rod-shaped portion of the contact portion 17 and the hole 2b.

The contact portion 17 is movable along the axis of the hole 2b. The packing 18 prevents water from infiltrating the inside of the main unit 2. A coil spring 21 is provided in the cavity 2c, and the coil spring 21 presses the contact portion 17 toward the first belt 7a. Accordingly, the contact portions 17 come in contact with the first terminal 11, the second terminal 12, the third terminal 13, and the fourth terminal 14.

A cantilevered conductive spring 22 extending toward the left side of the drawing is provided at the contact portion 17. The identifier 16 is provided within the main unit 2, and four terminals 16a are provided at the identifier 16. The conductive spring 22 slides while pressing the terminal 16a. The first terminal 11, the second terminal 12, the third terminal 13, the fourth terminal 14, the contact portion 17, the conductive spring 22, and the terminal 16a are made of conductive metal. Accordingly, the identifier 16 can detect electric resistance between the first terminal 11, the second terminal 12, the third terminal 13, and the fourth terminal 14. The identifier 16 detects the short circuit and non-short circuit states between the respective terminals such as the first terminal 11 to the fourth terminal 14 through the contact portions 17.

FIG. 4 is a schematic plan view showing a configuration of the wristwatch. An example in which a wristwatch 23 as the electronic device is configured such that a second design belt 24 as the exterior decoration unit is provided at the main unit 2 will be described. The second design belt 24 is a belt on which a picture of a grass field is drawn. The second design belt 24 includes a first belt 24a and a second belt 24b. The first belt 24a is provided on a lateral surface of the main unit 2 on the right side of the drawing, and the second belt 24b is provided on a lateral surface of the main unit 2 on the left side of the drawing. A second image 25 is displayed on the display device 3. Information 25a indicating a current time is included in the second image 25.

For example, when the second design belt 24 is provided at the main unit 2, the picture of the grass field is displayed on the second image 25 displayed on the display device 3. The second image 25 is a display content appropriate for the picture drawn on the second design belt 24 so as to correspond to the second design belt 24.

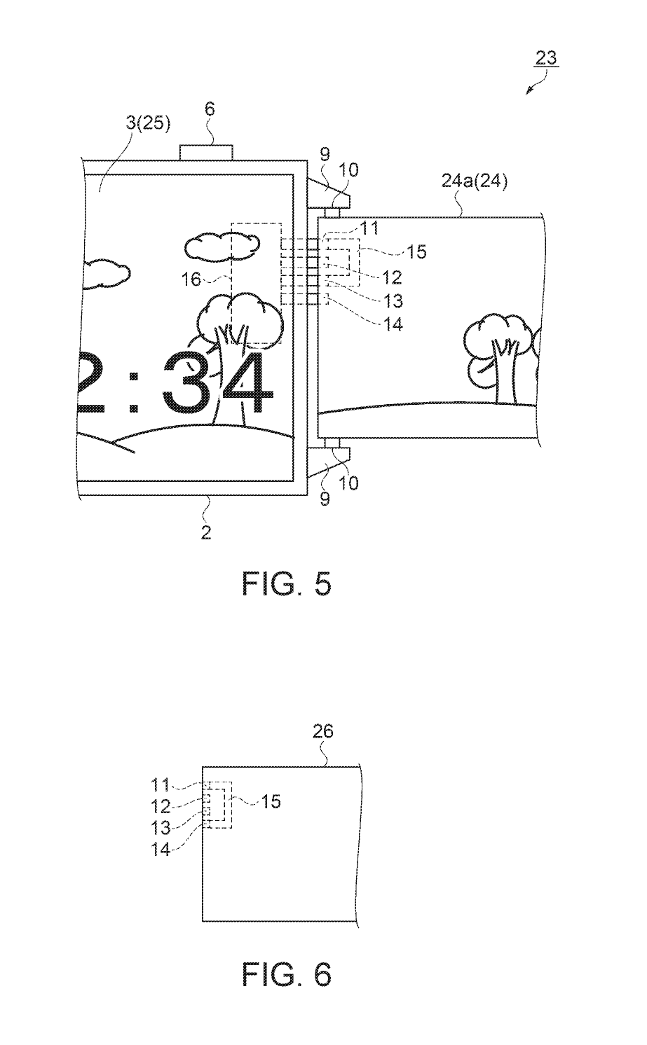

FIG. 5 is a schematic diagram of major portions for describing a coupling portion of the main unit and the second design belt. As shown in FIG. 5, the first terminal 11, the second terminal 12, the third terminal 13, and the fourth terminal 14 are provided at the first belt 24a. The first terminal 11 and the third terminal 13 are connected by the electrical wiring 15. The second terminal 12 and the fourth terminal 14 are independent terminals. The identifier 16 detects short circuit and non-short circuit states between the respective terminals. The identifier 16 identifies that the second design belt 24 is connected to the main unit 2.

FIG. 6 is a schematic plan view of major portions showing a configuration of a third design belt. As shown in FIG. 6, in a third design belt 26 as the exterior decoration unit, the first terminal 11 and the fourth terminal 14 are connected by the electrical wiring 15. The second terminal 12 and the third terminal 13 are independent terminals. When the third design belt 26 is provided at the main unit 2, the identifier 16 identifies that the third design belt 26 is connected to the main unit 2.

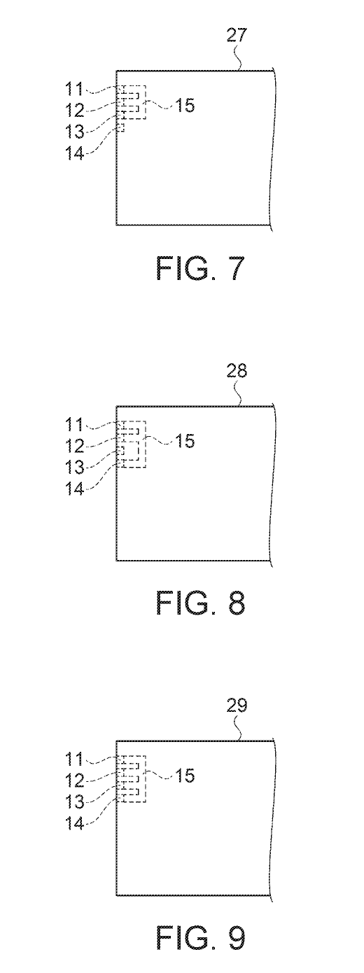

FIG. 7 is a schematic plan view of major portions showing a configuration of a fourth design belt. As shown in FIG. 7, in a fourth design belt 27 as the exterior decoration unit, the first terminal 11, the second terminal 12, and the third terminal 13 are connected by the electrical wiring 15. The fourth terminal 14 is an independent terminal. When the fourth design belt 27 is provided at the main unit 2, the identifier 16 identifies that the fourth design belt 27 is connected to the main unit 2.

FIG. 8 is a schematic plan view of major portions showing a configuration of a fifth design belt. As shown in FIG. 8, in a fifth design belt 28 as the exterior decoration unit, the first terminal 11, the second terminal 12, and the fourth terminal 14 are connected by the electrical wiring 15. The third terminal 13 is an independent terminal. When the fifth design belt 28 is provided at the main unit 2, an identifier 16 identifies that the fifth design belt 28 is connected to the main unit 2.

FIG. 9 is a schematic plan view of major portions showing a configuration of a sixth design belt. As shown in FIG. 9, in a sixth design belt 29 as the exterior decoration unit, the first terminal 11, the second terminal 12, the third terminal 13, and the fourth terminal 14 are connected by the electrical wiring 15. When the sixth design belt 29 is provided at the main unit 2, an identifier 16 identifies that the sixth design belt 29 is connected to the main unit 2.

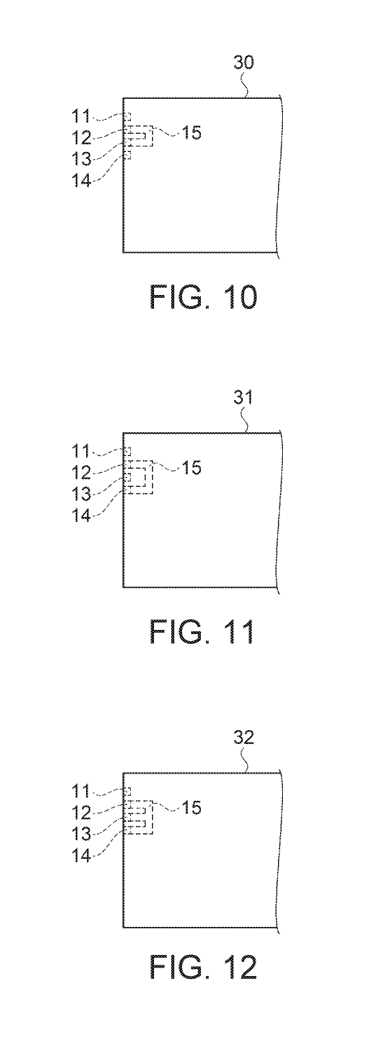

FIG. 10 is a schematic plan view of major portions showing a configuration of a seventh design belt. As shown in FIG. 10, in a seventh design belt 30 as the exterior decoration unit, a second terminal 12 and a third terminal 13 are connected by an electrical wiring 15. The first terminal 11 and the fourth terminal 14 are independent terminals. When the seventh design belt 30 is provided at the main unit 2, an identifier 16 identifies that the seventh design belt 30 is connected to the main unit 2.

FIG. 11 is a schematic plan view of major portions showing a configuration of an eighth design belt. As shown in FIG. 11, in an eighth design belt 31 as the exterior decoration unit, a second terminal 12 and a fourth terminal 14 are connected by an electrical wiring 15. The first terminal 11 and the third terminal 13 are independent terminals. When the eighth design belt 31 is provided at the main unit 2, an identifier 16 identifies that the eighth design belt 31 is connected to the main unit 2.

FIG. 12 is a schematic plan view of major portions showing a configuration of a ninth design belt. As shown in FIG. 12, in a ninth design belt 32 as the exterior decoration unit, a second terminal 12, a third terminal 13, and a fourth terminal 14 are connected by an electrical wiring 15. The first terminal 11 is an independent terminal. When the ninth design belt 32 is provided at the main unit 2, an identifier 16 identifies that the ninth design belt 32 is connected to the main unit 2.

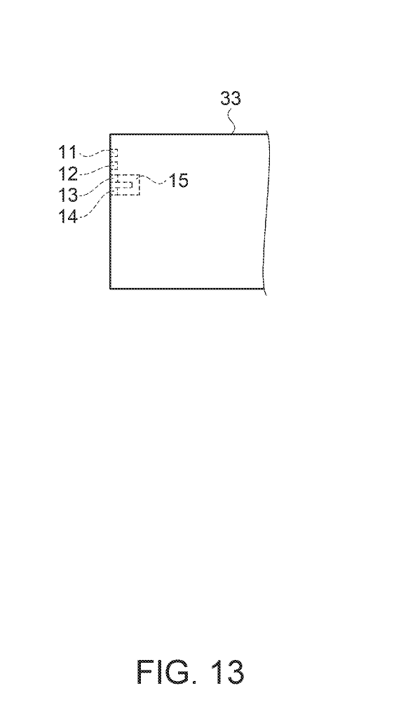

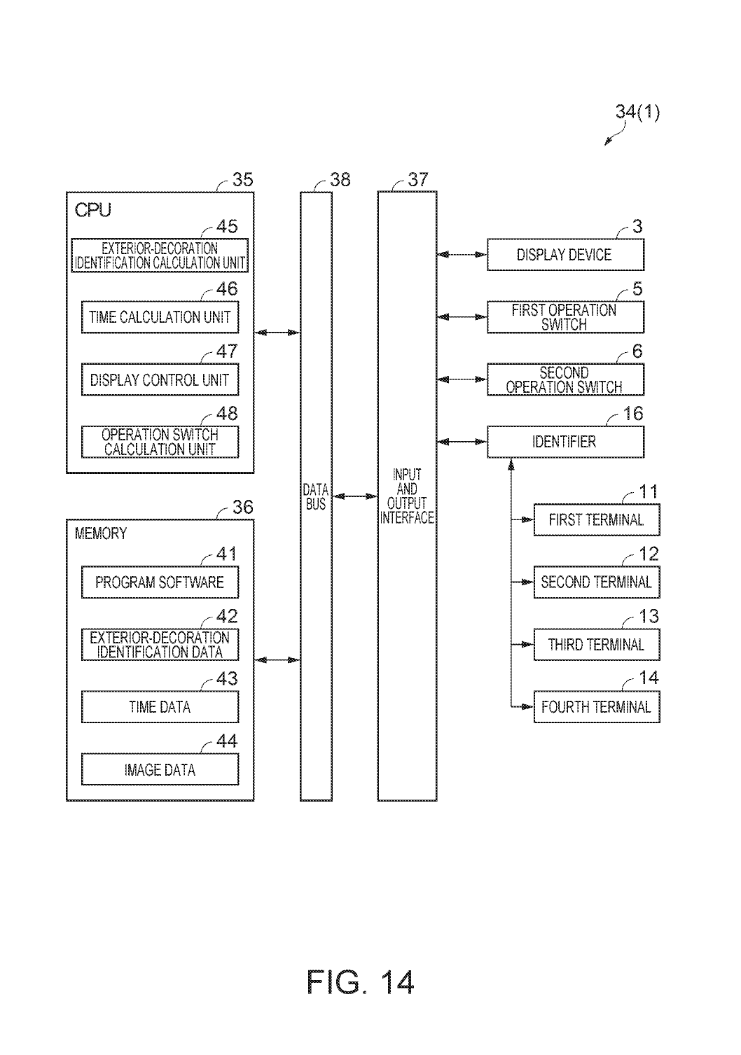

FIG. 13 is a schematic plan view of major portions showing a configuration of a tenth design belt. As shown in FIG. 13, in a tenth design belt 33 as the exterior decoration unit, a third terminal 13 and a fourth terminal 14 are connected by an electrical wiring 15. The first terminal 11 and the second terminal 12 are independent terminals. When the tenth design belt 33 is provided at the main unit 2, an identifier 16 identifies that the tenth design belt 33 is connected to the main unit 2.

The first design belt 7 to the tenth design belt 33 include the first terminal 11, the second terminal 12, the third terminal 13, and the fourth terminal 14, and the short circuit and non-short circuit states of the respective terminals are different in these belts. The identifier 16 detects the short circuit and non-short circuit states between the respective terminals, and thus, the identifier 16 identifies which belt of the first design belt 7 to the tenth design belt 33 is the belt connected to the main unit 2. That is, the identifier 16 identifies the belt by using the first terminal 11, the second terminal 12, the third terminal 13, and the fourth terminal 14.

FIG. 14 is an electric control block diagram of the wristwatch. In FIG. 14, the wristwatch 1 includes a control device 34 that controls the wristwatch 1. The control device 34 includes a CPU 35 (central processing unit) as a processor that performs various calculation processes, and a memory 36 as a storage unit that stores various information items. The display device 3, the first operation switch 5, the second operation switch 6, and the identifier 16 are connected to the CPU 35 through an input and output interface 37 and a data bus 38.

The display device 3 displays the display content such as the first image 4 or the second image 25. The information 4a indicating the current time is displayed on the first image 4, and the information 25a indicating the current time is displayed on the second image 25.

The first operation switch 5 and the second operation switch 6 are input means when the operator operates the wristwatch 1. The operator does a work for switching the content displayed on the display device 3 by operating the first operation switch 5 and the second operation switch 6.

The identifier 16 includes four contact portions 17, and the contact portions 17 come in contact with the first terminal 11, the second terminal 12, the third terminal 13, and the fourth terminal 14 which are provided at the belt. The identifier 16 detects the short circuit and non-short circuit states between the respective terminals. The identifier 16 identifies which belt of the first design belt 7 to the tenth design belt 33 is the belt connected to the main unit 2. Identification numbers corresponding to the first design belt 7 to the tenth design belt 33 are output the CPU 35. In each belt, at least a pair of terminals of the first terminal 11, the second terminal 12, the third terminal 13, and the fourth terminal 14 is short-circuited by the electrical wiring 15. When the belt is not provided at the main unit 2, resistance between four contact portions 17 is greater than a determination value. When resistance between four contact portions 17 is greater than the determination value, the identifier 16 outputs the identification number indicating that the belt is not provided at the main unit 2 to the CPU 35.

The memory 36 is a concept including a semiconductor memory such as a RAM or a ROM. Functionally, a storage area for storing program software 41 which describes a procedure of controlling the operation of the wristwatch 1 is set. In addition, a storage area for storing exterior-decoration identification data 42 indicating a correspondence table of the identification number of the belt with the number of the display content displayed on the display device 3 is set. In addition, a storage area for storing time data 43 which is data of the current time is set. A storage area for storing image data items 44 which are data items of the display contents displayed on the display device 3 is set. In addition, a storage area functioning as a work area or a temporary file for the CPU 35 or various other storage areas are set.

The CPU 35 performs control for displaying the display content and the current time on the display device 3 according to the program software 41 stored within the memory 36. The CPU 35 includes exterior-decoration identification calculation unit 45 as a specific function realizing unit. The exterior-decoration identification calculation unit 45 receives, as an input, data of the identification number output from the identifier 16. Image data 44 displayed on the display device 3 from the image data items 44 stored in the memory 36 is selected.

In addition, the CPU 35 includes a time calculation unit 46. The time calculation unit 46 calculates a current time every second, and outputs the time data 43. The time data 43 is stored in the memory 36.

In addition, the CPU 35 includes a display control unit 47. The time calculation unit 46 outputs the time data 43 to the display control unit 47. The display control unit 47 displays the display content corresponding to the belt identified by the identifier 16 on the display device 3. Initially, the display control unit 47 inputs the image data selected by the exterior-decoration identification calculation unit 45 from the memory 36. The display content indicating the current time is combined with the image data 44. Subsequently, the combined image data 44 is output to the display device 3. The display device 3 receives, as an input, the image data 44 combined with the current time, and displays the received image data. The exterior-decoration identification calculation unit 45 and the display control unit 47 are equivalent to a control unit.

In addition, the CPU 35 includes an operation switch calculation unit 48. The operation switch calculation unit 48 determines whether or not the first operation switch 5 and the second operation switch 6 are pressed. The content displayed on the display device 3 is changed by a combination of a state of the first operation switch 5 and a state of the second operation switch 6. For example, the operation switch calculation unit 48 changes a display format of the current time. In addition, the operation switch calculation unit 48 performs an operation for advancing or delaying the current time.

Although it has been described in the present embodiment that the respective functions are realized using the CPU 35 by using the program software, it may be possible to use such an electronic circuit in a case where the respective functions can be realized by a single electronic circuit without using the CPU 35.

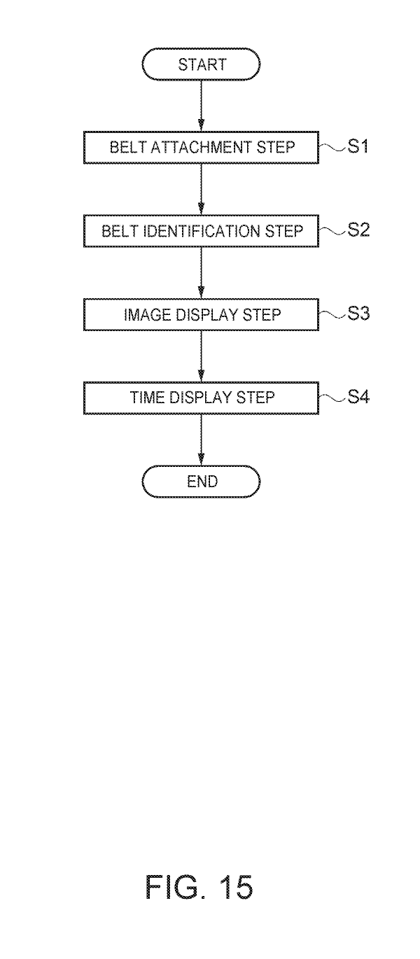

Next, a method of causing the above-described wristwatch 1 to change the display content displayed on the display device 3 so as to correspond to the attached belt will be described. FIG. 15 is a flowchart of a display content display method. In FIG. 15, step S1 is a belt attachment step. In this step, the operator changes the belt. Initially, the operator detaches the belt from the main unit 2. In this case, the identifier 16 detects that the belt is not attached to the main unit 2 since electric resistance between the contact portions 17 becomes high. The identifier 16 outputs information indicating that the belt is not attached to the exterior-decoration identification calculation unit 45.

The exterior-decoration identification calculation unit 45 selects the display content indicating that the belt is not attached from the image data 44. Subsequently, the selected display content is combined with the display content indicating the current time, and the combined display content is output to the display device 3. The display device 3 displays the display content indicating the belt is not attached and the current time. Subsequently, the operator selects one of the first design belt 7 to the tenth design belt 33, and attaches the selected belt to the main unit 2.

Step S2 is a belt identification step. In this step, the identifier 16 identifies which belt of the first design belt 7 to the tenth design belt 33 is the belt attached to the main unit 2. For example, an example when the first design belt 7 is attached to the main unit 2 will be described. Four contact portions 17 of the identifier 16 are pressed to the first terminal 11 to the fourth terminal 14. The identifier 16 detects the electric resistance between the respective terminals. In the first design belt 7, the electric resistance between the first terminal 11 and the second terminal 12 is low. In other combinations of the terminals, the electric resistance is high. The identifier 16 detects that the belt attached to the main unit 2 is the first design belt 7 from this condition. The identifier 16 outputs a signal indicating that the belt attached to the main unit 2 is the first design belt 7 to the exterior-decoration identification calculation unit 45.

Step S3 is an image display step. In this step, the display device 3 is a step of displaying the first image 4. Initially, the exterior-decoration identification calculation unit 45 receives, as an input, the signal indicating that the belt attached to the main unit 2 is the first design belt 7 from the identifier 16. Subsequently, the exterior-decoration identification calculation unit 45 searches for the data of the first image 4 which is the display content corresponding to the first design belt 7 from the image data 44 stored in the memory 36. The exterior-decoration identification calculation unit 45 outputs the data of the first image 4 to the display control unit 47.

The display control unit 47 receives, as an input, the data of the first image 4. The display control unit 47 combines the display content indicating the current time with the first image 4. Subsequently, the combined image data 44 is output to the display device 3. The display device 3 receives, as an input, the image data 44 combined with the current time, and displays the received image data.

Step S4 is a time display step. This step is a step of updating the information 4a indicating the current time displayed with the first image 4. The time calculation unit 46 calculates the current time. The display control unit 47 combines the display content indicating the current time with the first image 4. Subsequently, the combined image data 44 is output to the display device 3. The display device 3 receives, as an input, the image data 44 combined with the current time, and displays the received image data.

Step S4 is continued until the operator operates the first operation switch 5 or the second operation switch 6. Alternatively, this step is continued until the operator detaches from the first design belt 7 from the main unit 2. By performing the above-described stages, a step of causing the wristwatch 1 to change the display content displayed on the display device 3 so as to correspond to the attached belt ends.

As described above, according to the present embodiment, the following advantages are exhibited.

(1) According to the present embodiment, the wristwatch 1 includes the main unit 2, the first design belt 7, and the identifier 16. The first design belt 7 is detachably attached to the main unit 2. The identifier 16 identifies the first design belt 7. The wristwatch 1 includes the display device 3, the memory 36, the exterior-decoration identification calculation unit 45, and the display control unit 47. The display device 3 displays the first image 4, and the first image 4 displayed on the display device 3 is stored in the memory 36. The exterior-decoration identification calculation unit 45 searches for the first image 4 corresponding to the first design belt 7 identified by the identifier 16, and the display control unit 47 displays the searched image on the display device 3.

The operator can detach the first design belt 7 from the main unit 2, and can re-attach another belt to the main unit. The operator can attach a belt having a different design to the main unit 2. The identifier 16 identifies which belt of a plurality of belts having different designs is attached to the main unit 2. The image data items 44 corresponding to the belts are stored in the memory 36. The exterior-decoration identification calculation unit 45 reads the display content corresponding to the first design belt 7 identified by the identifier 16 from the memory 36, and the display control unit displays the read content on the display device 3. Accordingly, the wristwatch 1 can display the display content appropriate for any one of the first design belt 7 to the tenth design belt 33 on the display device 3.

(2) According to the present embodiment, the first design belt 7 to the tenth design belt 33 include the first terminal 11 to the fourth terminal 14. The first terminal 11 to the fourth terminal 14 include the electrical wiring 15 wired in a different pattern for each belt. The identifier 16 identifies the first design belt 7 to the tenth design belt 33 by using the first terminal 11 to the fourth terminal 14. Accordingly, the identifier 16 can reliably identify the first design belt 7 to the tenth design belt 33.

(3) According to the present embodiment, the first design belt 7 to the tenth design belt 33 include the first terminal 11 to the fourth terminal 14. The identifier 16 is connected to the first terminal 11 to the fourth terminal 14, and electrically identifies the first design belt 7 to the tenth design belt 33. Accordingly, the identifier 16 can easily identify the first design belt 7 to the tenth design belt 33.

(4) According to the present embodiment, the information 4a indicating the current time is included in the first image 4 displayed on the display device 3. The information 25a indicating the current time is included in the second image 25. Accordingly, the operator can check the current time while viewing the display content displayed on the display device 3.

### Second Embodiment

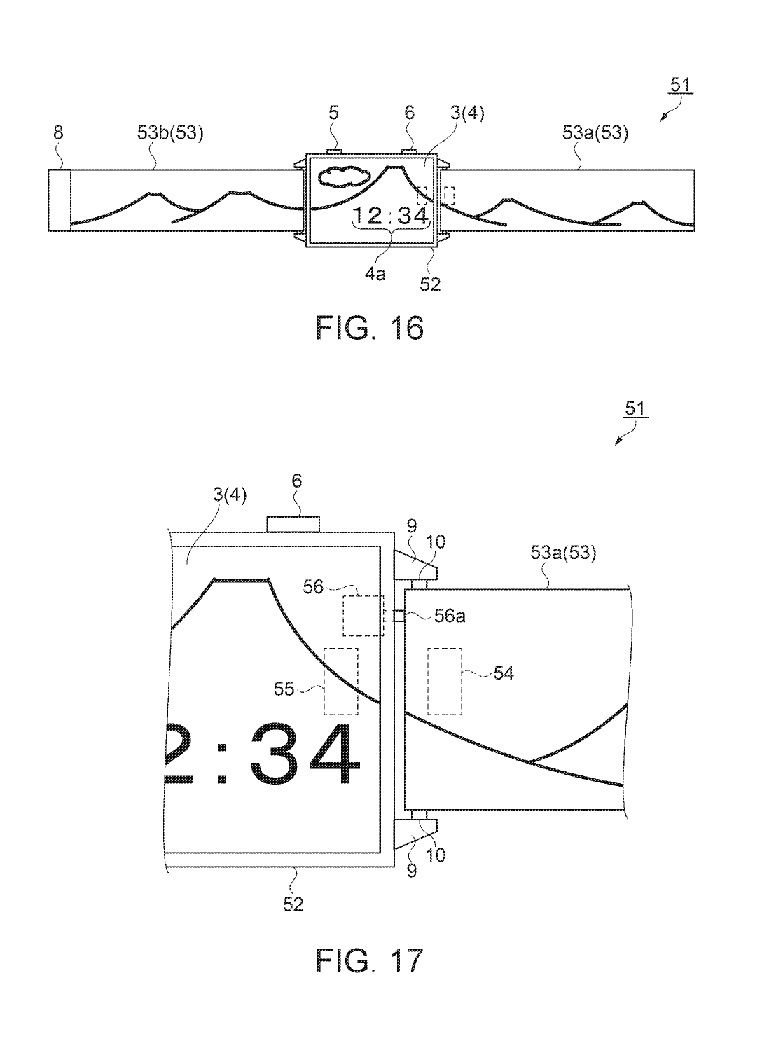

Next, an embodiment of the wristwatch will be described with reference to FIGS. 16 to 20. The present embodiment is different from the first embodiment in that the main unit 2 and the belt wirelessly communicate with each other in place of the method of causing the identifier 16 shown in FIG. 2 to identify the belt by using the first terminal 11 to the fourth terminal 14. The same description as that of the first embodiment will be omitted.

FIG. 16 is a schematic plan view showing a configuration of the wristwatch. As shown in FIG. 16, a wristwatch 51 as the electronic device includes a main unit 52, and the display device 3 is provided at the main unit 52. A first belt 53a is provided on a lateral surface of the main unit 52 on a right side of the drawing, and a second belt 53b is provided on a lateral surface of the main unit 52 on a left side of the drawing. A picture is drawn on the first belt 53a and the second belt 53b. The content of the picture is not particularly limited, and for example, a picture of a mountain chain is drawn on the first belt 53a and the second belt 53b in the present embodiment. It is assumed that the belt including the first belt 53a and the second belt 53b is a first design belt 53 as the exterior decoration unit. The first design belt 53 to the tenth design belt are also prepared at the wristwatch 51.

When the first design belt 53 is attached to the main unit 52, the picture of the mountain chain is displayed as the first image 4 displayed on the display device 3. The first image 4 is the display content appropriate for the picture drawn on the first design belt 53 so as to correspond to the first design belt 53. As another display content, a plurality of types of designs is prepared using belt design variations acquired by combining an image or a moving image of a character who appears in animation, cartoon, or movie with a design belt associated with this character, and the display contents selected by the respective belts are combined. Accordingly, the operator can enjoy various display contents through the changing of the belts.

FIG. 17 is a schematic diagram of major portions for describing a coupling portion of the main unit and the first design belt. As shown in FIG. 17, an identification signal transmission unit 54 as the identification feature unit is provided at the first belt 53a. The identification signal transmission unit 54 wirelessly transmits an identification signal specific to the first design belt 53. As a medium of the identification signal, light or a radio wave may be used. For example, in the present embodiment, the identification signal transmission unit 54 transmits the identification signal of the radio wave.

An identification signal reception unit 55 as the identification unit is provided within the main unit 52. The identification signal reception unit 55 receives the identification signal transmitted from the identification signal transmission unit 54. The identification signal is an identification signal specific to each belt. The identification signal reception unit 55 identifies the belt attached to the main unit 52 from the received identification signal.

An attachment and detachment detection unit 56 is further provided within the main unit 52. The attachment and detachment detection unit 56 includes a pressure sensor and a contact portion 56a connecting with the pressure sensor. The contact portion 56a protrudes from the main unit 52 toward the first belt 53a. When the first belt 53a is attached to the main unit 52, the first design belt 53 presses the contact portion 56a. In this case, the pressure sensor of the attachment and detachment detection unit 56 detects a load applied to the contact portion 56a. As stated above, the attachment and detachment detection unit 56 detects the attachment or detachment of the belt to or from the main unit 52.

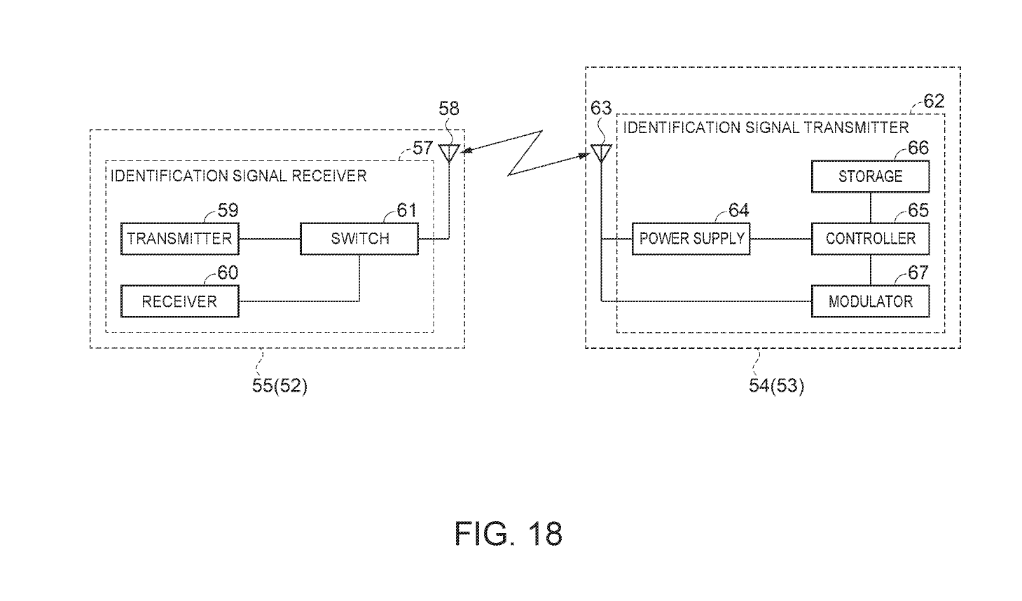

FIG. 18 is a circuit diagram of the identification signal transmission unit and the identification signal reception unit. As shown in FIG. 18, the identification signal reception unit 55 includes an identification signal receiver 57 and a second antenna 58. A transmitter 59, a receiver 60, and a switch 61 are provided in the identification signal receiver 57. The second antenna 58, the transmitter 59, and the receiver 60 are connected to the switch 61 through an electrical wiring. The switch 61 switches circuits between a circuit that connects the second antenna 58 and the transmitter 59 and a circuit that connects the second antenna 58 and the receiver 60.

The switch 61 outputs a transmission signal output from the transmitter 59 from the second antenna 58. The switch 61 outputs a reception signal received by the second antenna 58 to the receiver 60. The switch 61 switches between the output of the transmission signal and the input of the reception signal by using one second antenna 58 by switching the circuits.

The identification signal transmission unit 54 includes an identification signal transmitter 62 and a first antenna 63. A power supply 64, a controller 65, a storage 66, and a modulator 67 are provided in the identification signal transmitter 62. The power supply 64, the storage 66, and the modulator 67 are connected to the controller 65 through an electrical wiring. The first antenna 63 is connected to the power supply 64 and the modulator 67 through an electrical wiring.

The power supply 64 changes an alternating current (AC) waveform received by the first antenna 63 to a direct current waveform, and stores electricity. The power supply 64 supplies power to the controller 65, the storage 66, and the modulator 67. Waveforms of identification signals different for the belts are stored in the storage 66. The controller 65 receives, as an input, the identification signal from the storage 66 in accordance with a timing when the AC waveform received by the first antenna 63 is stopped, and outputs the received identification signal to modulator 67. The modulator 67 modulates the identification signal such that the identification signal can be output from the first antenna 63. The first antenna 63 outputs the radio wave including the identification signal.

Next, the operations of the identification signal reception unit 55 and the identification signal transmission unit 54 will be described. Initially, the transmitter 59 outputs the AC waveform to the second antenna 58 via the switch 61. The transmission signal output from the second antenna is the AC waveform, and is intermittently output at predetermined intervals. Apart of the AC waveform output from the second antenna 58 is received by the first antenna 63.

When the radio wave of the AC waveform is input to the first antenna 63, the AC waveform is input to the power supply 64. The power supply 64 rectifies the AC waveform, stores electricity, and supplies power to the controller 65, the storage 66, and the modulator 67. Waveform data of the identification signal of the first design belt 53 is stored in the storage 66. When the AC waveform input to the first antenna 63 is stopped, the controller 65 receives, as an input, the waveform data of the identification signal from the storage 66, and outputs the received waveform data to the modulator 67. The modulator 67 modulates the waveform of the identification signal, and outputs the modulated waveform to the first antenna 63.

The waveform including the modulated identification signal is output from the first antenna 63. A part of the waveform of the identification signal output from the first antenna 63 is input to the second antenna 58. The reception signal received from the second antenna 58 passes through the switch 61, and is input to the receiver 60. The receiver 60 demodulates the reception signal, and acquires the waveform of the identification signal. The receiver 60 identifies that the belt attached to the main unit 52 is the first design belt 53 from the identification signal.

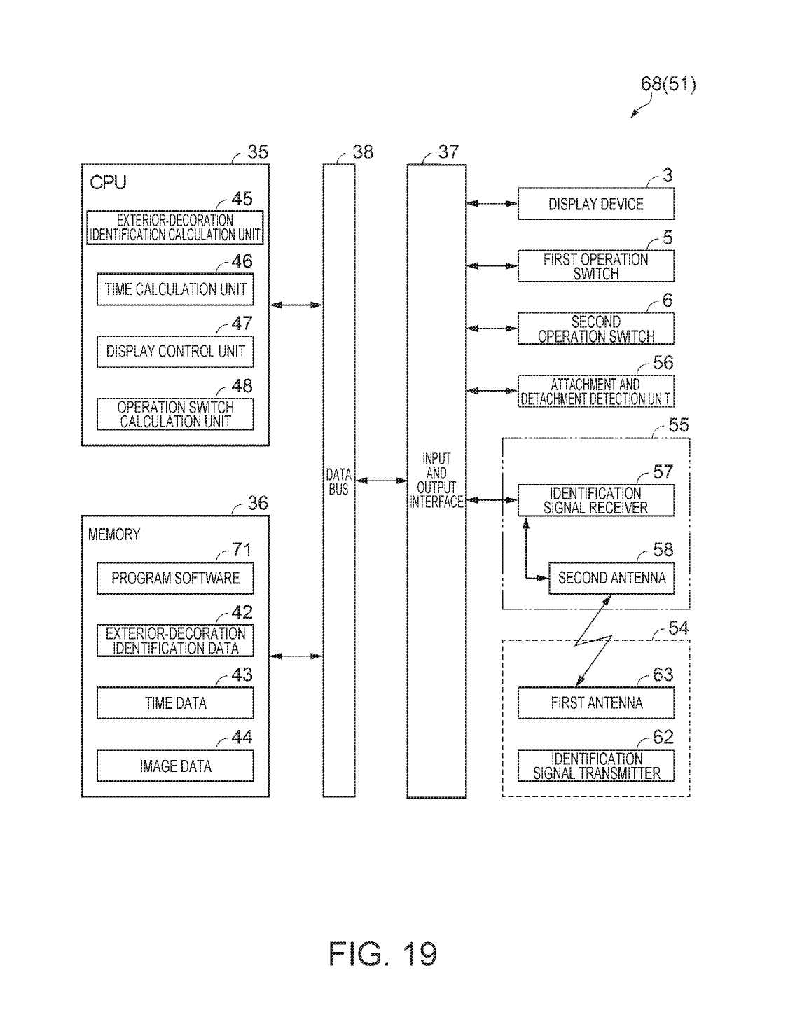

FIG. 19 is an electric control block diagram of the wristwatch. In FIG. 19, the wristwatch 51 includes a control device 68 that controls the wristwatch 51. In the control device 68, the attachment and detachment detection unit 56 and the identification signal receiver 57 of the identification signal reception unit 55 are connected to the CPU 35 through the input and output interface 37 and the data bus 38.

A storage area for storing program software 71 which describes a procedure of controlling the operation of the wristwatch 51 is set in the memory 36. The control procedure of the program software 71 is a procedure of acquiring the identification signal of the belt from the identification signal reception unit 55.

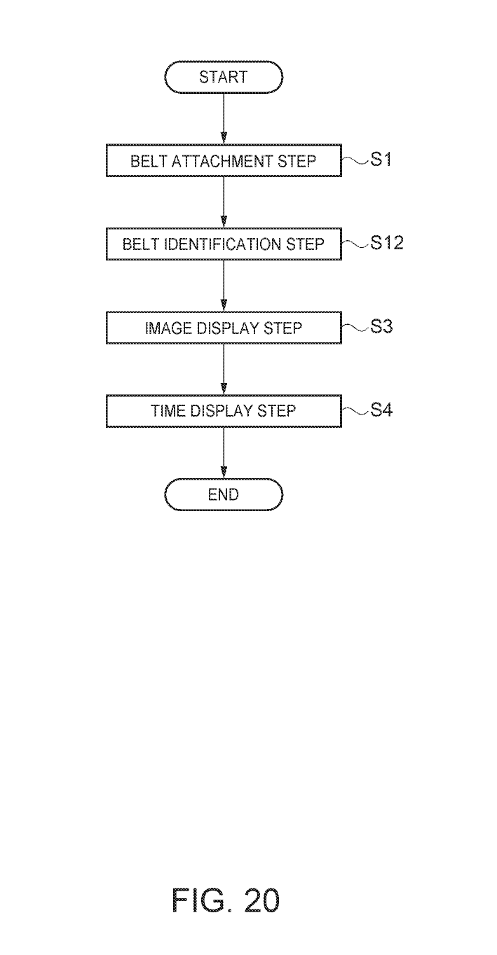

Next, a method of causing the wristwatch 51 to change the display content displayed on the display device 3 so as to correspond to the attached belt will be described. FIG. 20 is a flowchart of the display content display method. In FIG. 20, after the belt attachment step of step S1, a belt identification step of step S12 is performed. After step S12, an image display step of step S3 and a time display step of step S4 are performed.

Step S1, step S3, and step S4 are the same as those in the first embodiment, and the description thereof will be omitted. Step S12 will be described. This step is a step of identifying which belt of the first design belt 53 to the tenth design belt is the belt attached to the main unit 52. When the belt is attached to the main unit 52, the contact portion 56a is pressed by the belt. The pressure sensor provided at the attachment and detachment detection unit 56 detects a pressure applied to the contact portion 56a.

As stated above, the attachment and detachment detection unit 56 detects the attachment or detachment of the belt to or from the main unit 52. Subsequently, the attachment and detachment detection unit 56 outputs a signal indicating that the belt is attached to the main unit 52 to the exterior-decoration identification calculation unit 45. The exterior-decoration identification calculation unit 45 receives the signal, and outputs an instruction signal to detect the identification signal to the identification signal reception unit 55. The identification signal reception unit 55 transmits the radio wave of the transmission signal from the second antenna 58.

Subsequently, the identification signal transmission unit 54 receives the radio wave of the transmission signal by the first antenna 63. Thereafter, the identification signal transmission unit 54 transmits the radio wave of the identification signal from the first antenna 63. Subsequently, the identification signal reception unit 55 receives the radio wave of the identification signal by the second antenna 58. The identification signal receiver 57 detects that the belt attached to the main unit 52 is the first design belt 53 from the identification signal, and outputs the detected identification signal to the exterior-decoration identification calculation unit 45. As stated above, when the attachment and detachment detection unit 56 detects the attachment of the belt to the main unit 52, the identification signal reception unit 55 communicates the identification signal.

As described above, according to the present embodiment, the following advantages are exhibited.

(1) According to the present embodiment, the identification signal transmission unit 54 includes the first antenna 63, and the first antenna 63 outputs the radio wave signal including the identification signal. The identification signal reception unit 55 includes the second antenna 58, and the second antenna 58 receives, as an input, a radio signal including the identification signal. Accordingly, the identification signal reception unit 55 can identify the belt by the identification signal transmission unit 54 in a non-contact manner. As a result, even though a surface of the belt is contaminated, the identification signal reception unit 55 can identify the belt.

(2) According to the present embodiment, the attachment and detachment detection unit 56 detects the attachment or detachment of the belt to or from the main unit 52. When the main unit 52 and the belt are coupled, the identification signal reception unit 55 communicates the identification signal. Accordingly, since the number of times of the identification signal reception unit 55 and the identification signal transmission unit 54 communicating with each other can be reduced, it is possible to reduce power consumed in the communication of the identification signal reception unit 55 with the identification signal transmission unit 54.

The present embodiment is not limited to the above-described embodiment, and may be variously changed or modified by those skilled in the art within the technical ideals of the invention. Modification examples will be described below.

### Modification Example 1

In the first embodiment, four terminals of the first terminal 11 to the fourth terminal 14 are provided at the belt. The number of terminals may be two or three, or may be five or more. The terminals may be provided in accordance with the number of types of the belts. It is possible to manufacture the belt with higher productivity in a case where the number of terminals is small than in a case where the number of terminals is large.

### Modification Example 2

In the first embodiment, when the belt is changed, the display content displayed on the display device 3 is changed. An exterior decoration covering a part of the main unit 2 in addition to the belt may be provided at the main unit 2, and the display content displayed on the display device 3 may be changed when this exterior decoration is changed.

### Modification Example 3

In the first embodiment, a still image is displayed on the display device 3. A moving image appropriate for the picture of the belt may be displayed on the display device 3.

### Modification Example 4

In the first embodiment, the belt is identified using the electric resistance between the first terminal 11 to the fourth terminal 14. Reflection surfaces having different reflectance values may be formed instead of the first terminal 11 to the fourth terminal 14, and a device that detects the reflectance values of the reflection surfaces may be provided instead of the identifier 16. In such a case, it is possible to identify the belt. In addition, protrusions and recesses may be formed on the lateral surface of the belt. The protrusions and recesses are formed in different patterns for the types of the belts. A device that detects the pattern of the protrusions and recesses may be provided instead of the identifier 16. In such a case, it is possible to identify the belt. The contents of Modification Example 1 to Modification Example 4 may also be applied to the second embodiment.

### Modification Example 5

In the second embodiment, the attachment and detachment detection unit 56 is provided at the main unit 52. The attachment and detachment detection unit 56 may be omitted. The belt attached to the main unit 52 may be identified by regularly operating the identification signal reception unit 55. The display content displayed on the display device 3 may be changed depending on the belt. Since the attachment and detachment detection unit 56 is not provided, it is possible to manufacture the wristwatch 51 with high productivity.

### Modification Example 6

In the second embodiment, the communication of the identification signal is performed by a simple procedure. A communication protocol or a communication method for communicating the identification signal is not particularly limited, and FeliCa (registered trademark), ISO/IEC 14443 (MIFARE) (registered trademark), ISO/IEC 18092, NFC Bluetooth (registered trademark), Handover (registered trademark), or TransferJet (registered trademark) may be used. It is possible to perform highly reliable communication.

The entire disclosure of Japanese Patent Application No. 2016-054963, filed Mar. 18, 2016 is expressly incorporated by reference herein.

What is claimed is:

1. An electronic device comprising:
a main unit;
an exterior decoration unit that is detachably attached to the main unit;
an identification unit that identifies the exterior decoration unit;
a display unit that displays display contents;
a storage unit that stores the display contents displayed on the display unit; and
a control unit that displays the display content corresponding to the exterior decoration unit identified by the identification unit on the display unit.

2. The electronic device according to claim 1,
wherein the exterior decoration unit includes an identification feature unit, and
the identification unit identifies the exterior decoration unit by using the identification feature unit.

3. The electronic device according to claim 2,
wherein the identification feature unit includes an electrical terminal.

4. The electronic device according to claim 2,
wherein the identification feature unit includes a first antenna that outputs an identification signal, and
the identification unit includes a second antenna that receives, as an input, the identification signal.

5. The electronic device according to claim 4, further comprising:
an attachment and detachment detection unit that detects attachment or detachment of the exterior decoration unit to or from the main unit,
wherein the identification unit communicates the identification signal when the attachment and detachment detection unit detects the attachment of the exterior decoration unit to the main unit.

6. The electronic device according to claim 1,
wherein information indicating a current time is included in the display content.
